(19) United States
(12) Patent Application Publication
(10) Pub. No.: US 2013/0290385 A1
(43) Pub. Date: Oct. 31, 2013

(54) DURABLY RECORDING EVENTS FOR PERFORMING FILE SYSTEM OPERATIONS

(71) Applicants: Charles B. Morrey, III, Palo Alto, CA (US); Kimberly Keeton, San Francisco, CA (US); Craig A. Soules, San Francisco, CA (US); Alistair Veitch, Mountain View, CA (US); Michael J. Spitzer, Portland, OR (US); Corene Casper, Pleasant Grove, UT (US)

(72) Inventors: Charles B. Morrey, III, Palo Alto, CA (US); Kimberly Keeton, San Francisco, CA (US); Craig A. Soules, San Francisco, CA (US); Alistair Veitch, Mountain View, CA (US); Michael J. Spitzer, Portland, OR (US); Corene Casper, Pleasant Grove, UT (US)

(21) Appl. No.: 13/460,624

(22) Filed: Apr. 30, 2012

(51) Int. Cl. G06F 17/30

(52) U.S. Cl. 707/822; 707/E17.01

(57) ABSTRACT

Multiple file system events are detected on one or more nodes of a file system, each file system event corresponding to an operation that is to be performed on the file system. Each of the multiple system events are durably recorded as an entry for a journal of the file system prior to either performance or completion of the corresponding operation. A programmatic component that is external to the file system can process entries from the journal, and in response, the entries can be expired from the journal.

### BACKGROUND

File systems provide an organized storage medium for files. Distributed file systems allow access to files from multiple nodes that communicate across a network (e.g., enterprise network).

### BRIEF DESCRIPTION OF THE DRAWINGS

FIG. 1 illustrates an example node that is configured to durably journal file system operations, according to an embodiment.

FIG. 2 illustrates an example system for durably journaling events that occur on different nodes of a distributed file system, according to one or more embodiments.

FIG. 3 includes an example method for durably journaling events that occur on different nodes of a distributed file system, according to one or more embodiments.

FIG. 4 illustrates an alternative example for implementing aggregation operations in connection with journaling operations performed on individual file system nodes, under an embodiment.

FIG. 5 illustrates an example computing system to implement functionality such as provided by embodiments described herein.

### DETAILED DESCRIPTION

Embodiments described herein provide for a scalable and reliable system for recording events relating to file system operations. Some embodiments include a system or method in which file system operations initiated on a node of a distributed file system environment are journaled asynchronously, and then subsequently stored for analysis. The types of analysis that can be performed based on the recorded events include, for example, compliance or auditing analysis pertaining to use of the distributed file system.

According to some embodiments, multiple file system events are detected on one or more nodes of a distributed file system. Each file system event corresponds to an operation that is to be performed on the file system. The detected events are durably recorded as an entry within a journal for the node prior to either performing or completing the corresponding operation at the node. In some embodiments, a programmatic component that is external to the file system can process entries from the journal, and in response, the entries can be expired from the journal.

The term “durable” or variants thereof (e.g., “durably”) in the context of storing data or information means such data is stored in a manner that is resilient to computing failure and data loss over time. For example, durably recorded data can be stored on a non-volatile storage medium such as a disk drive for subsequent analysis or use.

One or more embodiments described herein provide that methods, techniques and actions performed by a computing device (e.g., node of a distributed file system) are performed programmatically, or as a computer-implemented method. Programmatically means through the use of code, or computer-executable instructions. A programmatically performed step may or may not be automatic.

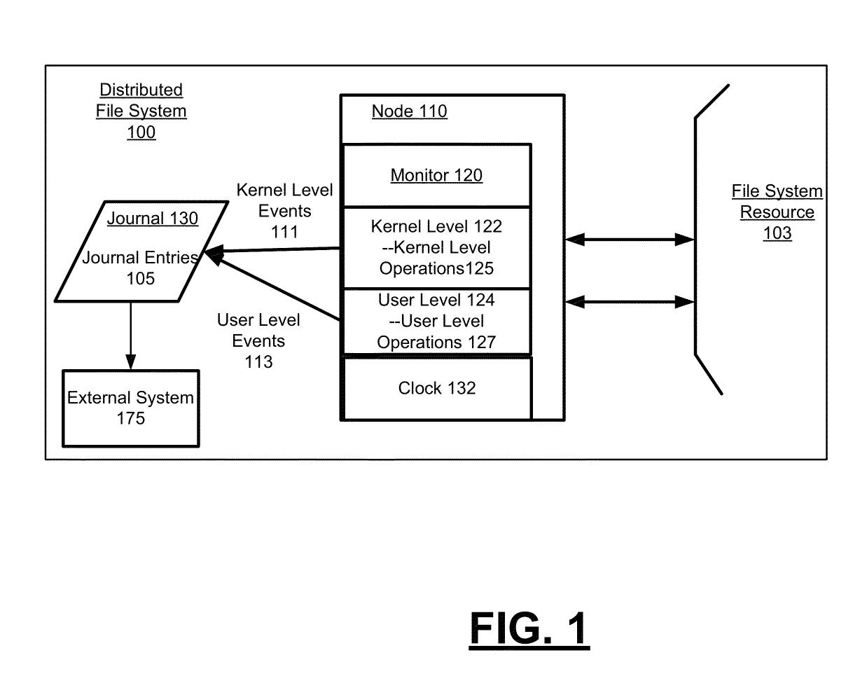

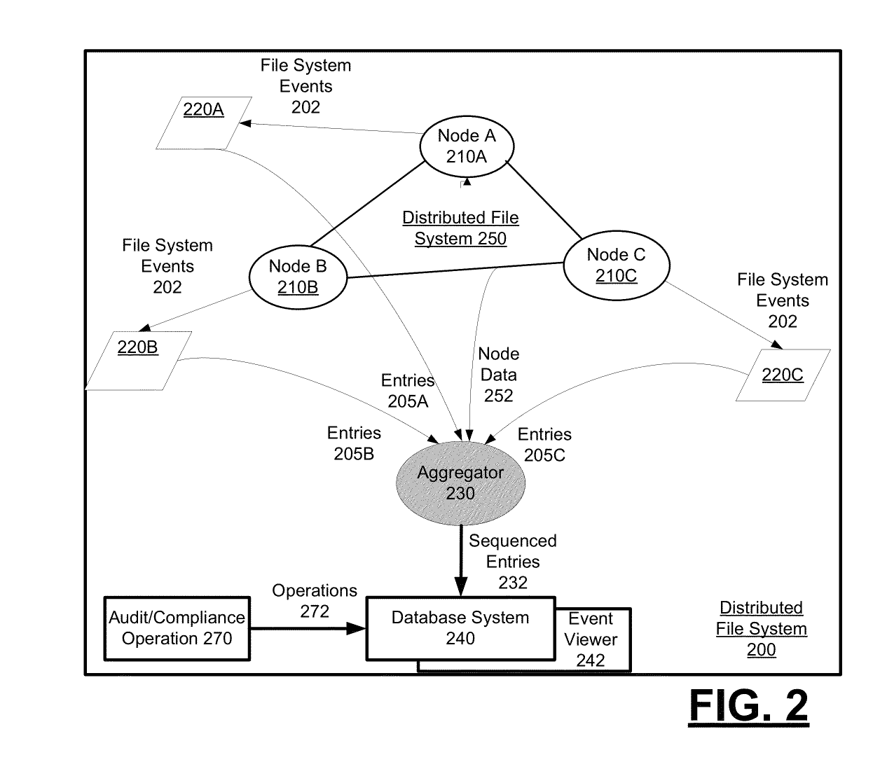

With reference to FIG. 1 or FIG. 2, one or more embodiments described herein may be implemented using programmatic modules or components. A programmatic module or component may include a program, a subroutine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Node Description

FIG. 1 illustrates an example node of a distributed file system that is configured to durably journal file system operations, according to an embodiment. In particular, a node 110 can participate as one of multiple nodes 110 that comprise a distributed or parallel file system 100. The distributed file system 100 can be implemented using, for example, an IBRIX file system (provided by HEWLETT PACKARD COMPANY), or LUSTRE file system (available under open source license). The file system 100 can implement, for example, the LINUX EXT3 physical file system. As a distributed system, the file system 100 can reside in whole or in part on a machine (e.g., server, work station) on which node 110 also resides. The node 110 can communicate with file system resources 103, including other nodes, data stores etc. Optionally, the use of file system resources 103 can involve performance of kernel level operations 125 and/or user level operations.

In an embodiment, a monitoring component 120 is provided on node 110 to monitor for file system events. Each file system event can correspond to an intent event, where the node 110 is to perform a corresponding file system operation (e.g., file system modification). The file system events can represent file system operations such as read, write, or changes in permission. Additionally, the file system events identify relevant parameters for such modifications, such as file names, number of bytes read, user name and timestamps. The node 110 may include or otherwise utilize a journal 130, and the monitoring component 120 durably records different file system events in the journal 130 as journal entries 105. In one implementation, the entries 105 can correspond to metadata (rather than file content) that represent a corresponding operation. The journal 130 marks individual entries 105 as uncommitted until confirmation is received that the file contents of the operations represented by the entries 105 have been written to non-volatile storage (e.g. hard disk) within the file system 100. After confirmation is received, the journal 130 marks the entries 105 as being committed.

In a variation, the entries 105 can include file content data, and in the event of a failure (e.g., a power outage, system or software crash, network failure etc.), the node 110 can utilize the entries marked as uncommitted to replay a sequence of file system operations that were in flight (or not written to disc) at the time the failure occurred.

According to embodiments, the entries 105 for the file system events are recorded asynchronously with, or independently of, performance of the corresponding operation. Thus, for example, the individual entries 105 can be recorded in the journal 130 before the operation that corresponds to the represented event is complete. At the same time, the entries 105 are durably stored, and their recording in the journal 130 signifies a commitment that the underlying operations represented by the individual entries 105 will be performed, even in the presence of file system, node or network failure.

According to embodiments, different types of events are recorded in the journal 130. In particular, the monitoring component 120 can include kernel level logic 122 which detects kernel level events 111. The kernel level event 111 can correspond to the intent to perform or the initiation of one or more kernel level operations 125 by node 110. Examples of kernel level operations 125 include delete, read, write, and rename, as well as some system wide operations. The kernel level events 111 can also identify the parameters that are relevant to the corresponding operation such as file name, number of bytes read, user etc., and time stamps (as described further below).

The monitor component 120 can also include user level logic 124 that detects user level events 113, which can correspond to node 110 initiating one or more user level operations 127. In variations, the monitoring functionality can be implemented in part or in whole by (i) a kernel for file system 100, which can write out journal entries for kernel-level events, and (ii) user-level applications which write events using a user-level journaling mechanism. The user-level operations 127 can be programmatically generated, or initiated by user tagging or input. The user level events 113 can also identify the parameters that are relevant to the corresponding operation such as file name, user-defined tag, user name and time stamps (as described further below).

Each of the kernel and user level events 111, 113 are recorded as entries 105 in the journal 130. The entries 105 for the different events may be sequenced in the journal 130. For example, the node 110 can maintain a clock 132 that is synchronized with, for example, clocks of other nodes that comprise the file system 100. In particular, embodiments provide that entries 105 generated from both user and kernel level events 111, 113 are interleaved and sequenced in the journal 130 based on timestamps provided from the clock 132.

In an embodiment, journal 130 is provided as an EXT3 file. The monitoring component 120 is programmed to generate entries that reflect the operation that is to occur (corresponding to the event), as well as to record from the clock 132 a timestamp for the journal entry 105. Other parameters (e.g., file name, file content, user, data size) that are relevant to the corresponding file system operation of the detected event are also identified and recorded as an entry 105 of journal 130.

In some embodiments, the particular operations that are deemed events and recorded in the journal 130 are specified by the administrator. Thus, for example, an administrator can modify the set of operations that are logged with the journal 130. Specific kernel level operations 125 can be pre-identified for logging using, for example, a kernel interface such as a UNIX FCNTL or similar system call. Similarly, user level operations 127 can be pre-identified for logging using kernel interface calls such as UNIX FCNTL or other similar system calls.

While an example of FIG. 1 illustrates the node 110, one or more embodiments can be implemented as part of a single node, with a corresponding physical file system and journal. For example, one example of an embodiment provides for a single node, with a non-distributed file system, which can detect and durably record entries for file system events (e.g., kernel level operations 125, user level operations 127).

According to one or more embodiments, an external system 175 (e.g., a database) can be provided individual entries 105 from the journal 130. The journal 130 can be synced, or otherwise coordinated, with the external system 175, so that journal entries 105 are expired from the journal 130 when those entries are accessed or processed by the external system 175. As examples, the external system 175 can correspond to a database (e.g., see database system 240 of FIG. 2), aggregator (e.g., see aggregation component 230 of FIG. 2), event viewer or log.

System Description

FIG. 2 illustrates an example system for durably journaling events that occur on different nodes of a file system, according to one or more embodiments. A system 200 such as described with an embodiment of FIG. 2 may be implemented using multiple nodes 210A, 210B, 210C (collectively referred to as nodes 210) of a distributed file system 250. In embodiments, each of the nodes 210 may be implemented in a manner such as described with an embodiment of FIG. 1. The nodes 210 of system 200 may reside on one or more machines. Thus, the individual nodes 210 can be either logically or physically distinct. Additionally, the set of nodes 210 may also utilize a distributed file system 250, similar to examples recited with an embodiment of FIG. 1.

Among other benefits, an embodiment such as described with FIG. 2 enables a reliable and scalable system for recording journal entries representing various kinds of file system operations, performed on multiple nodes of the distributed file system 250. As a result, system 200 enables implementation of various compliance or audit based operations. For example, as described, entries for events can be aggregated/stored in a database and then searched or queried. For example, an auditor could retrieve all events that occurred during a prescribed time period to determine if policy violations had occurred. Such compliance or audit based operations can, for example, reflect a state of the file system 250 at a particular instance of time, even after events such as failure by one or more of the nodes of the file system 250.

As described with an embodiment of FIG. 1, each node 210 includes components for monitoring file system operations on the distributed file system 250. The monitored file system operations can include both kernel and user level operations. The nodes 210 journal file system events 202, representing the node's initiation or intent to perform such kernel or user level operations, as well as relevant parameters of the represented operation (e.g., file name, number of bytes read, user name and time stamps). In this way, the file system events are journaled asynchronously with, or independent of performance of the respective corresponding file system operations.

In an embodiment, each node 210A, 210B, 210C includes a corresponding journal 220A, 220B, 220C in which respective entries 205A, 205B, 205C representing the file system operations are recorded. The entries 205A, 205B, 205C that are recorded in the respective journals 220A, 220B, 220C can correspond to metadata that represent a corresponding operation performed on the corresponding node 210A, 210B, 210C. In embodiments, each node 210A, 210B, 210C may mark the individual entries of the respective journals 220A, 220B, 220C as uncommitted until confirmation is received that the file contents of the file system operations represented by those entries have been written to, for example, the disk. Then each of the nodes 210A, 210B, 210C can mark their respective entries as being committed.

In some variations, data content journaling can also be used, so that the entries 205A, 205B, 205C specify data content and metadata. In the event of a failure, such as a power outage, the individual node 210A, 210B, 210C where the failure occurred can utilize the entries of the corresponding journal 220A, 220B, 220C which are marked as uncommitted to replay a sequence of file system operations that were in flight (or not written to disk) at the time the failure occurred.

According to embodiments, the entries of each journal 220A, 220B, 220C provided for each node are recorded asynchronously with that node's performance of the corresponding file system operation. Thus, the entries can be, for example, recorded in the corresponding journals 220A, 220B, 220C before the operation represented by that journal entry is complete. At the same time, each node 210A, 2108, 210C durably stores its entries in the corresponding journal 220A, 220B, 220C, and the entries can be aggregated or otherwise accessed by other components (e.g., aggregation component 230 and/or database system 240). In some variations, the aggregation of the entries representing the file system events 202 of the various nodes 210 provides an ability for the underlying operations represented by those entries to be available for analysis, even in the presence of some failures, such as file system, node or network failure. For example, the entries representing the file system events 202 can be stored in a database that can be queried, searched, and/or analyzed, to enable compliance or auditing operations to be performed in connection with use of the file system.

According to one or more embodiments, system 200 includes one or more aggregation components 230 and the database system 240 (or node of a distributed database system). In variations, other systems or components, such as an event viewer 242, can be implemented as an addition or alternative to the database system 240. In the example shown by FIG. 2, the aggregation component 230 is centralized, so that one aggregation component 230 operates for some or all of the nodes 210 of distributed file system 250. In this way, the aggregation component 230 batch processes the entries of the various journals 220. The aggregation component 230 can be centralized, or it can be distributed (e.g., reside with nodes). The ability for the aggregation component 230 to batch process entries 205 further facilitates scaling of system 200 to include additional nodes and resources. In an embodiment, the aggregation component 230 operate to receive entries 205A, 205B, 205C (collectively “entries 205”) from each of the respective journals 220A, 220B, and 220C (collectively “journals 220”). In one embodiment, the aggregation component 230 determines which nodes 210 are active based on node data 252 provided from the file system 250. Once the nodes are identified to the aggregation component 230, the nodes 210 are able to individually communicate entries 205 of their respective journals to the aggregation component 230 using, for example, call back routines initiated by the respective nodes. In variations, the aggregation component 230 polls the individual nodes 210 for entries 205 of their respective journals.

The aggregation component 230 can optionally operate to sequence the entries 205 from the various nodes 210. The sequencing of the entries 205 can be based on, for example, time stamps associated with the individual entries. As noted with, for example, FIG. 1, each node 210A, 2108, 210C can time stamp its individual entries. In this way, the aggregation component 230 can aggregate the entries 205 from multiple nodes 210 of the file system 250, and collectively sequence the events based on the time stamps associated with the individual entries 205A, 205B, 205C from the respective nodes. In this way, the aggregation component 230 aggregates and interleaves entries 205, representing different types of events (e.g., kernel level operations, user level operations), from each node of the file system 250. As an alternative or addition, the ability of individual nodes 210A, 210B, 210C to timestamp entries can be utilized in database operations to sequence of entries as needed.

The aggregation component 230 provides the sequenced list of entries 232 for ingestion by the database system 240 (or with other component such as event viewer 242). For example, the database system 240 may import the sequenced entries 232, once the entries of the different nodes are aggregated and sequenced by the aggregation component 230. By using time stamps on each of the entries 205A, 205B, 205C, journal entry updates may be batched and then communicated to the database system 240 in any order. The timestamps on each of the journal entries can be used to determine which updates are kept if there are multiple entries for a single database record. As shown, system 200 can be implemented to reliably record journal entries 205A, 205B, 205C, reflecting kernel and user level events on the nodes 210A, 210B, 210C of the file system 250. For example, journal files 220A, 220B, 220C can be reliably maintained amongst the nodes 210A, 210B, 210C because each node is able to durably journal events with synchronized use of timestamps. Thus, the file system journals are reliably maintained even in the event of node failure resulting from, for example, a system crash, a software crash, or network failure.

Additionally, embodiments recognize that reliably maintaining records of journaling operations on each node further enhances the ability of the system 200 to scale. For example, each node 210A, 2108, 210C (or machine thereof) can store its own respective journal 220A, 220B, 220C. If a particular machine, for example, runs out of disk space or otherwise fails, then the auditable operations that occurred on that machine will result in errors, but other machines or nodes of the file system 250 will be unaffected. As another example, the failure of one node in implementing a mufti-node auditable operation (e.g., rename, in which the operation is initiated on one node and completed on another node) can result in the operation not being completed on any of the nodes that are involved in the operation. The journal entries can potentially be aggregated or retrieved from one or both nodes involved in the operation in order to enable, for example, fault analysis to be performed to determine information about the cause or source of the error.

Embodiments further recognize that the reliability inherent in system 200 promotes various auditing or compliance operations. In particular, embodiments recognize that the reliably and durable manner in which journal entries 205 are recorded can be used to enable additional auditing or compliance functionality for a variety of purposes. In some embodiments, an operation interface 270 for database system 240 can operate to enable auditing or compliance operations 272, such as to determine (i) who has accessed a file, (ii) verify that correct retention or deletion events have taken place, (iii) verify correct setting of file security properties, (iv) enable compliance tracking for an archive, (v) change notification for virus scanner, (vi) enable backups, including backup of applications, (vii) enable remote replication, and/or (viii) enable validation scanning, or other applications that would otherwise be required to scan the complete file system for file changes.

The system 200 can be implemented to enable journals that record the various file system events to be synchronized with external systems, such as database system 240 or event viewer 242. In an embodiment, the entries 205A, 205B, 205C of the journals 220A, 220B, 220C can be expired when the journals are processed by the external system (e.g., imported or stored with the database system 240). Moreover, by storing the entries in, for example, the database system 240, embodiments enable operations such as indexing, parsing and searching to be performed, resulting in better analysis and understanding of the various file system operations.

Methodology

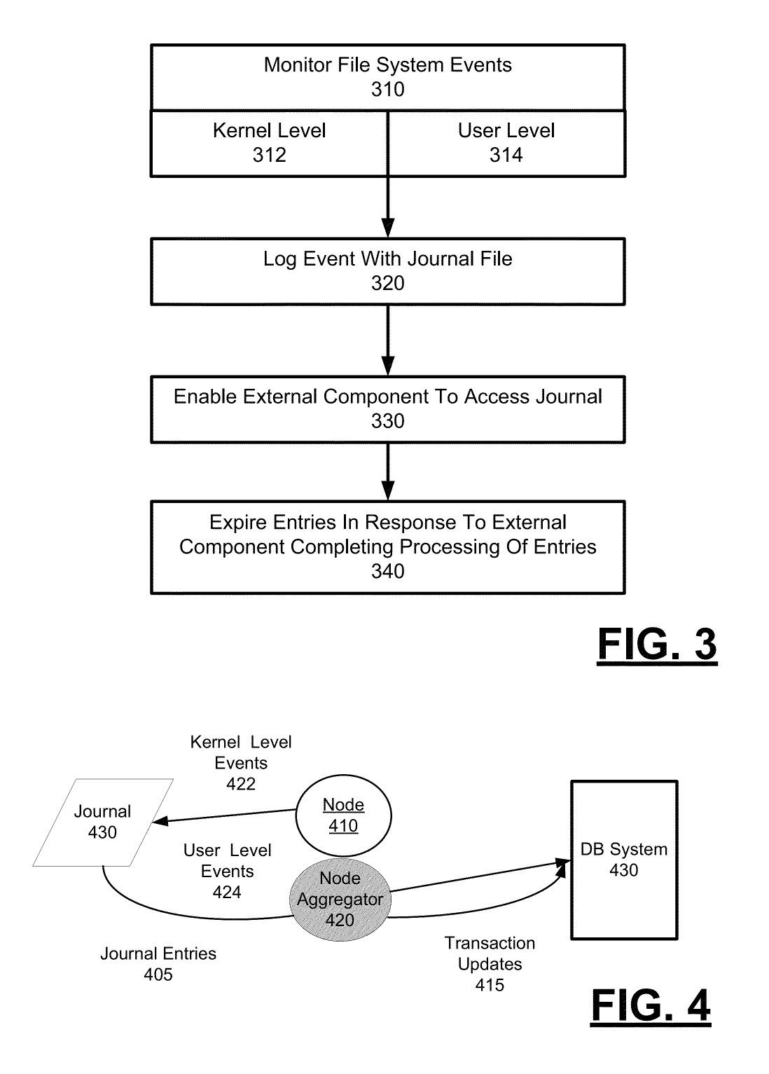

FIG. 3 includes an example method for durably journaling events that occur on different nodes of a file system, according to one or more embodiments. A method such as described by an embodiment of FIG. 3 may be performed using, for example, components of a system such as described with an embodiment of FIG. 2. Accordingly, reference may be made to elements of FIG. 2 for purpose of illustrating a suitable component or element for performing a step of sub-step being described.

In an embodiment, file system events are monitored on individual nodes 210A, 2108, 210C of a distributed file system 200 (310). Each node 210A, 210B, 210C can detect kernel level events (312), which represent a kernel level operation performed on that node. Each node 210A, 210B, 210C may also be able to detect user level events (314). Furthermore, each of the kernel and user level events may include parameters and metadata associated with performance of the corresponding operation, such as file name, number of bytes affected, the time stamp and the user name.

Each node 210A, 210B, 210C records its detected events as entries with the corresponding journal 220A, 220B, 220C (320). Under an embodiment, each of the nodes 210A, 210B, 210C, stores its own journal, so that failure of that node does not affect the journaling performed at other nodes. In this way, the entries of the journals 220A, 220B, 220C include metadata that identifies the various operations that are to, or which are, taking place. When a file system operation represented by an individual entry is complete, the node 210A, 210B, 210C marks the entry representing that entry as complete. In this way, each of the journals 220A, 220B, 220C record events that include file system operations that are in flight, or which are not yet initiated.

The entries of the journal files can be made available to an external component (330). For example, a component such as provided by aggregation component 230 can collect entries from the individual journals. The external component can sequence the events from different nodes, then import the sequenced journal entries for processing. For example, the aggregation component 230 can import the sequenced entries into the database system 240 of the file system 250. Some embodiments recognize that batch processing journal entries from different nodes 210A, 210B, 210C enhances the scalability of the system 200. To this end, each node 210A, 2108, 210C can implement functional callbacks with, for example, a centralized aggregation component 230 or other programmatic component. For example, the aggregation component 230 can sequence the entries and cause the entries to be stored in the database system 240. The use of functional callbacks can be in place of, for example, polling operations (which could alternatively be performed), to further enhance the scalability of the system 200.

According to embodiments, the entries of various journals 220A, 220B, 220C can be expired, in response to the programmatic component (e.g., database system 240) completing processing of those entries (340). For example, the entries of the journal files can be garbage collected when the entries are marked complete, coinciding with the entry being reliably stored off the node (e.g., within the database system 240). In variations, the journal entries may be retained until the database has been backed up or otherwise replicated to a different node. In this way, the journals 220A, 220B, 220C can provide a mechanism by which file system events are synchronized by external systems.

Distributed Aggregation

While an embodiment of FIG. 2 illustrates use of a centralized aggregation component, other embodiments provide for use of a distributed aggregation component. In particular, FIG. 4 illustrates an alternative example for implementing aggregation operations in connection with journaling operations performed on individual file system nodes, according to one or more embodiments.

More specifically, with reference to an embodiment of FIG. 4, a node 410 for a distributed file system may be equipped to include an aggregation component 420. The node 410 can correspond to some or all of the nodes used by the distributed file system. As with, for example, an embodiment of FIG. 1, the node 410 includes a journal 430 for recording kernel and/or user level events 422, 424. The kernel and/or user level events 422, 424 are recorded in journal 430 in advance of the node's performance of the corresponding file system operation.

In an embodiment, aggregation component 420 resides with the node 410 and directly communicate entries 405 of the journal 430 to the database component 434. In particular, journal entries 405 may be communicated as transaction updates 415 from the node to the database component 434. The transaction updates 415 may be processed by the database 434 in order of arrival and synchronously, before the transaction updates are returned as success or failure. In this way, the database system 430 can maintain data reflecting the various entries 405, and database resources can enable searching and analysis to be performed in connection with auditing or compliance type operations. At the same time, the corresponding journal entries 405 can be removed from the journal 430. Thus, for example, the database system 430 provides a record of the events that resulted in the generation of journal entries 405 at a given instance of time.

As an addition or alternative, a node such as described with an embodiment of FIG. 4 may be implemented in the context of a distributed database. In such context, each node can include aggregation functionality in which entries of its journal files are continuously retried and provided as transactional updates to the corresponding node of the distributed database system.

Hardware Diagram

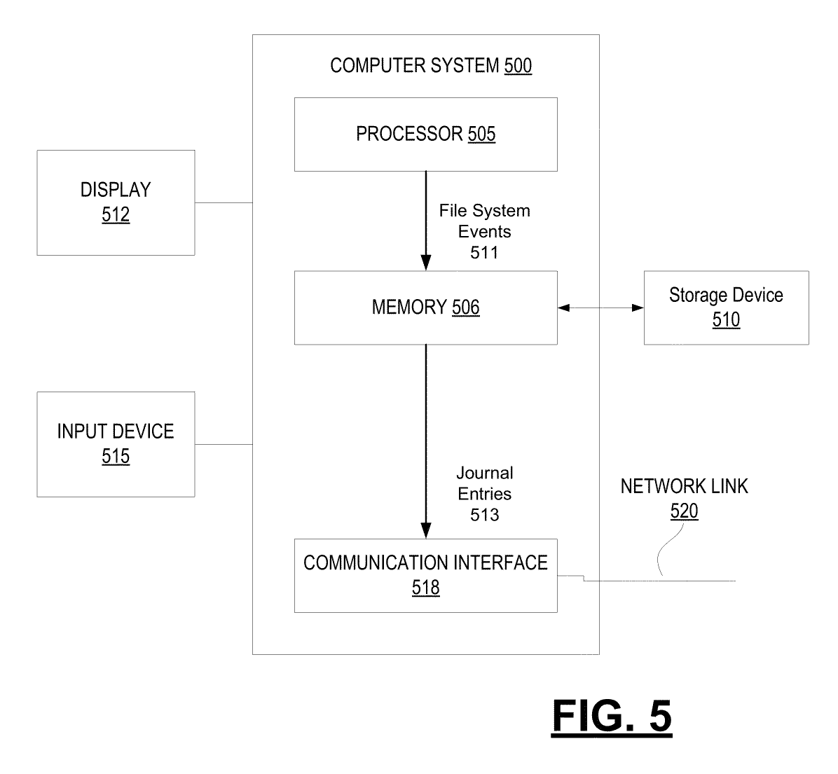

FIG. 5 illustrates an example computing system to implement functionality such as provided by embodiments described by FIG. 1 through FIG. 4. In an embodiment, computer system 500 includes at least one processor 505 for processing instructions. Computer system 500 also includes a memory 506, such as a random access memory (RAM) or other dynamic storage device, for storing information and instructions to be executed by processor 505. The memory 506 can include a persistent storage device, such as a magnetic disk or optical disk, for storing journal entries, as described with various embodiments. The memory 506 can also include read-only-memory (ROM). The communication interface 518 enables the computer system 500 to communicate with one or more networks through use of the network link 520.

Computer system 500 can include display 512, such as a cathode ray tube (CRT), a LCD monitor, or a television set, for displaying information to a user. An input device 515, including alphanumeric and other keys, is coupled to computer system 500 for communicating information and command selections to processor 505. Other non-limiting, illustrative examples of input device 515 include a mouse, a trackball, or cursor direction keys for communicating direction information and command selections to processor 505 and for controlling cursor movement on display 512. While only one input device 515 is depicted in FIG. 5, embodiments may include any number of input devices 515 coupled to computer system 500.

The computer system 500 may be operable to implement functionality described with a node of a distributed file system. Accordingly, computer system 500 may be operated to implement file system operations, including user and kernel level operations. In performing the operations, the computer system 500 records events 511 corresponding to the file system operations, which are recorded as entries 513 in a journal of the computing system 500. The entries 511 of the journal identify the file system operations in advance of those operations being performed, as well as parameters (e.g., metadata) associated with the individual operations. The computer system 500 can also execute instructions to communicate, via for example, call back operations, to communicate the journal entries 513 to a database system. For example, in one implementation, the computer system 500 can communicate the entries 513 to an aggregation component of a database or database system. In some variations, the computer system 500 may also implement an aggregation component such as described with an embodiment of FIG. 2 or FIG. 4.

The communication interface 518 can be used to communicate file system operations, such as described with embodiments of FIG. 1 through FIG. 4. Furthermore, the communication interface 518 can be used to communicate, for example, journal entries to the aggregation component 230 (see FIG. 2), or transactional updates 415 (see FIG. 4) to the database system 434.

Embodiments described herein are related to the use of computer system 500 for implementing the techniques described herein. According to one embodiment, those techniques are performed by computer system 500 in response to processor 505 executing one or more sequences of one or more instructions contained in memory 506. Such instructions may be read into memory 506 from another machine-readable medium, such as a storage device 510. Execution of the sequences of instructions contained in main memory 506 causes processor 505 to perform the process steps described herein. In alternative embodiments, hard-wired circuitry may be used in place of or in combination with software instructions to implement embodiments described herein. Thus, embodiments described are not limited to any specific combination of hardware circuitry and software.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A method for performing file system operations, the method being implemented by one or more processors and comprising:
(a) detecting multiple file system events, each file system event corresponding to an operation that is to be performed on a file system;
(b) durably recording each of the multiple file system events as an entry in a journal of the file system prior to either performance or completion of the corresponding operation;
(c) enabling a programmatic component that is external to the file system to process entries from the journal; and
(d) expiring one or more entries of the journal in response to the programmatic component completing processing of the one or more entries.

2. The method of claim 1, wherein each file system event identifies a corresponding file system operation that is to be performed, and wherein the (b) includes recording a set of parameters associated with the corresponding file system operation as part of the entry.

3. The method of claim 1, wherein at least one of the multiple file system events is one of a user level event that corresponds to a user level operation, or a kernel level event that corresponds to a kernel level operation.

4. The method of claim 3, wherein (a) includes detecting each of the user level event for the corresponding user level operation and a kernel level event for a corresponding kernel level operation.

5. The method of claim 4, further comprising sequencing the entries for the multiple file system events based on a time stamp associated with each of the multiple file system events.

6. The method of claim 1, wherein (a) and (b) are performed on multiple nodes that comprise a distributed file system, and wherein (c) includes aggregating the entries recorded on each node with the programmatic component.

7. The method of claim 1, wherein (c) includes aggregating the entry for each of the multiple file system events in a database.

8. The method of claim 6, further comprising:
aggregating the entries from the multiple nodes to a centralized data store, and
sequencing, at the centralized data store, the entries for each of the multiple file system events from the multiple nodes.

9. The method of claim 6, wherein aggregating the entries includes performing a batch process to record the entries from each of the multiple nodes.

10. The method of claim 8, further comprising enabling one or more compliance or auditing operations to be performed on the sequenced entries at the centralized data store.

11. The method of claim 8, further comprising enabling the centralized data store to be queried in connection with performance of one or more compliance or auditing operations.

12. The method of claim 1, wherein (d) includes removing individual entries from the journal after the entry has been communicated to an associated data store of the file system.

13. A computer system comprising:
a set of one or more nodes for a file system, wherein each node
(a) detects multiple file system events, each file system event corresponding to an operation that is to be performed on a file system;
(b) durably records each of the multiple file system events as an entry in a journal of the file system prior to either performance or completion of the corresponding operation;
(c) enable a programmatic component that is external to the file system to process entries from the journal; and
(d) expire one or more entries of the journal in response to the programmatic component completing processing of the one or more entries

14. The computer system of claim 13, further comprising an aggregation component that aggregates the entries in the journal for each node in the set of nodes.

15. A computer-readable medium that stores instructions, which when executed by one or more processors, cause the one or more processors to perform operations comprising:
(a) detecting multiple file system events, each file system event corresponding to an operation that is to be performed on a file system;
(b) durably recording each of the multiple file system events as an entry in a journal of the file system prior to either performance or completion of the corresponding operation;
(c) enabling a programmatic component that is external to the file system to process entries from the journal; and
(d) expiring one or more entries of the journal in response to the programmatic component completing processing of the one or more entries.
